(19) United States
(12) Patent Application Publication
(10) Pub. No.: US 2018/0327557 A1
(43) Pub. Date: Nov. 15, 2018

(54) Method Of Manufacturing A Thermoplastic Molding Compound Powder

(71) Applicant: Emery Oleochemicals GmbH, Dusseldorf (DE)

(72) Inventor: Manfred Jaeckel, Loxstedt (DE)

(21) Appl. No.: 15/957,944

(22) Filed: Apr. 20, 2018

(30) Foreign Application Priority Data
Apr. 28, 2017 (DE) 10 2017 004 180.6

(51) Int. Cl. C08J 5/12; C08J 3/12; C08J 3/09; C08K 5/105; B29C 64/153

(52) U.S. Cl. CPC C08J 5/12; C08J 3/122; C08J 3/095; C08K 5/105; B29C 64/153; C08J 2323/00; B29K 2105/251; C08J 2333/08; C08J 2339/06; C08J 2375/04; B29K 2909/02; B29K 2909/08; B29K 2905/00; C08J 2325/06

(57) ABSTRACT

The present invention relates to a method of manufacturing thermoplastic molding compound powder that consists of or comprises spherical or approximately spherical molding compound particles from a suspension of glass-like and/or ceramic and/or metallic substrate particles in a solvent in which a binder is dissolved that has a polymer soluble in the solvent, wherein the binder furthermore has one or more additives soluble in the solvent, with the method comprising the step of spray drying the suspension and with the spray drying being carried out such that the solvent partially or completely transitions into the gas phase.

The present invention relates to a method of manufacturing a thermoplastic molding compound powder.

It is known from the prior art to prepare feedstock compounds from which molded products are obtained in one or more further processing steps. A thermoplastic molding compound powder is in particular to be understood within the framework of the invention as a powdery feedstock compound from which a molded product is obtained in one or more further steps, e.g. by sintering.

Powdery feedstock compounds are accessible in accordance with the prior art, for example, in that pellets produced by thermoplastic molding are comminuted either in a wet or dry process in a comminution process such as by a grinding process.

The powders manufactured in this manner have a jagged geometry and a highly differing particle size, predominantly in the range from 0.01 mm to 1.0 mm.

Due to the jagged particle geometry, these powders or feedstock compounds have a comparatively small bulk density and have a poor flowability in the particle range below 0.1 mm.

These two properties of the powder determined by a grinding process are problematic for specific application technologies, in particular when a high packing density of a powder feedstock is aimed for or when the powder is to be applied very uniformly in a thin film, e.g. using a doctor blade.

The so-called powder foaming of ceramic or metallic molding compounds such as is described in EP 2 295 390 B1 can be named as an example for these application technologies as can the use of powdery molding compounds as sinterable feedstock for the additive production by means of selective laser sintering (SLS).

In both cases a sinterable green compact is produced that is subsequently debound, i.e. in which the binder is partially or completely removed, and a sintering process is subsequently carried out to obtain the desired green compact.

In the SLS process, a high green density, i.e. a high density of the molding compound particles forming the molding compound, is advantageous in the green compact so that a density of the molded product is obtained that is as dense as possible in the subsequent sintering process. It is of advantage here for spherical molding compound particles to be used.

The spherical shape of the molding compound particles is also advantageous to obtain a good flowability of the molding compound particles during coating with a doctor blade of the individual layers to be lasered.

Powdery molding compound particles are advantageous for both production techniques that are spherical, that have particle sizes below 0.2 mm, and that are additionally present in high bulk densities.

It is thus the underlying object of the present invention to provide powdery molding compounds that have one or more properties, and preferably all of said properties, i.e. whose particles have a spherical geometry, which flow freely, and which are present in a high bulk density.

This object is achieved by a method having the features of claim 1.

Provision is accordingly made that the thermoplastic molding compound powder consisting of or comprising spherical molding compound particles is obtained from a suspension of ceramic and/or metallic and/or glass-like substrate particles in a solvent by spray drying.

A binder is dissolved in the solvent and has at least one polymer that is soluble in the solvent.

The binder furthermore has one or more additives that are soluble in the solvent and that are preferably molecularly dissolved therein.

These additives can, for example, be one or more of the substances plasticizer, mold lubricant, additives, that form an at least binary system with the polymer.

The additive is preferably a substance that influences the rheological behavior of the polymer.

The polymer is preferably thermoplastic.

The polymer can be selected from one or more of the substances. Polycondensates such as, but not limited to, polyamides or polyesters; polymerizates such as, but not limited to, polyolefins, polystyrenes, polyacrylates, polyvinyl pyrrolidones, polyoxymethylenes; or polyadducts such as, but not limited to, polyurethanes. This list is not exclusive; further polymers are generally also conceivable.

On a spray drying of the suspension, the solvent transitions partially or completely into the gas phase and the ceramic and/or metallic and/or glass-like substrate particles form agglomerates in the form of the spherical molding compound particles in so doing. Solid, largely spherical molding compound particles whose ceramic and/or metallic and/or glass-like particles are held together by the binder arise from the droplets that include the ceramic and/or metallic and/or glass-like particles due to the atomizing and the simultaneous evaporation of the solvent of the suspension.

It is pointed out at this time that the term “spherical” also includes “largely spherical”. A ball-shaped body or a body approximated to the ball shape is preferably to be understood by it.

It is furthermore pointed out that the terms “a” and “one” do not necessarily mean that exactly one of the elements in question is present even though this is a possible embodiment of the invention. A plurality of the elements in question is also covered by the term “a” or “one”.

The evaporation can be promoted by the supply of a heated gas stream such as air or nitrogen or another gas.

Spherical molding compound particles are created by the process of spray drying. The process of spray drying is characterized in that the substances to be acquired are present either dissolved in a liquid or dispersed. A preferably warm air stream of a gas such as air or nitrogen is supplied during spray drying. Solid, spherical molding compound particles, which are also to be understood as largely spherical molding compound particles, arise from the droplets due to the atomizing and due to the simultaneous evaporation of the liquid by the supply of said gas stream.

A substantial component of the method in accordance with the invention is thus the spray drying by which spherical molding compound particles, i.e. spherical molding compound powders, are generated, i.e. powders that consist of or include spherical molding compound particles.

In an embodiment of the invention, the binder, such as the polyamide(s) dissolvable in alcohol, is molecularly dissolved in the suspension. The binder holds the ceramic and/or metallic and/or glass-like substrate particles together during and after the spray drying so that they can form the molding compound particles. They are sufficiently stable to be able to be subjected to further processing steps.

The solvent is preferably one or more alcohols or one or more alcoholic media.

If is preferred if the plasticizer is an ester of an aromatic hydroxybenzoic acid and is preferably a p-hydroxybenzoic acid fatty alcohol ester, with the length of the carbon chain preferably being in the range C12-C26, particularly preferably in the range C18-C22.

The metallic substrate particles that are present in the suspension preferably have a mean size in the range from 5 μm to 25 μm, preferably in the range from 10 μm bis to μm and particularly preferably 15 μm.

The ceramic substrate particles that are present in the suspension preferably have a mean size in the range from 0.1 μm to 5 μm.

In the case of glass-like substrate particles that are present in the suspension, they preferably have a mean size in the range from 1.0 μm to 50 μm.

The molding compound particles that form the thermoplastic molding compound powders and that include a plurality of ceramic and/or metallic and/or glass-like substrate particles and the binder preferably have a size in the range from >0.05 mm and/or <0.2 mm, preferably 0.05 mm to 0.15 mm, and particularly preferably 0.10 mm.

Said size can be the largest dimension of the ceramic and/or metallic and/or glass-like substrate particles or of the molding compound particles and/or their diameters.

Provision is preferably made that the molding compound particles each have a maximum dimension Aₘₐₓ and 0.005 mm≤Aₘₐₓ≤0.3 mm, in particular 0.008 mm≤Aₘₐₓ≤0.2 mm, and in particular 0.01 mm≤Aₘₐₓ≤0.1 mm applies to at least 80% of the molding compound particles.

Provision can furthermore be made that the molding compound particles each have a minimum dimension Aₘᵢₙ and a maximum dimension Aₘₐₓ and 0.6≤Aₘᵢₙ/Aₘₐₓ≤1, in particular 0.7≤Aₘᵢₙ/Aₘₐₓ≤1, and in particular 0.8≤Aₘᵢₙ/Aₘₐₓ≤1 applies to at least 80% of the molding compound particles.

It is furthermore conceivable that the substrate particles each have a maximum dimension Bₘₐₓ and 1 μm≤Bₘₐₓ≤50 μm, in particular 5 μm≤Bₘₐₓ≤40 μm, and in particular 10 μm≤Bₘₐₓ≤30 μm applies to at least 80% of the molding compound particles (3).

The substrate particles preferably consist of glass, ceramics, precious metal, hard metal, non-ferrous metal, iron, titanium, or steel, of one or more of their alloys, superalloys or compounds thereof, or comprise one or more of these substances or metals, alloys or compounds. As stated above, the substrate particles can also be such that consist of ceramics and/or glass or that comprise ceramics and/or glass.

In a preferred embodiment of the invention, the ceramic and/or metallic substrate particles are first introduced into a solvent such as an alcoholic solution comprising the binder and this suspension is then atomized in a spray system with a partial or complete evaporation of the solvent. The ceramic and/or metallic and/or glass-like substrate particles here form spherical agglomerates in the form of the molding compound particles.

Provision is preferably made that the introduction of the ceramic and/or metallic and/or glass-like substrate particles into the solvent takes place at elevated temperature, preferably at a temperature in the range from 60° C. to 80° C., and particularly preferably at 70°.

Provision is preferably made that the spray process is carried out at a temperature that is 10° C.-30° C., preferably 20° C., below the crystallization temperature of the polymer of the binder.

After the entry of the ceramic and/or metallic and/or glass-like powder or of the substrate particles into the solution, this suspension is preferably directly atomized in a preferably explosion-proof spray system, with the temperature being selected such that the solvent completely or partially evaporates.

In a conceivable embodiment, the spray process is carried out such that the suspension is sprayed into a liquid in which the binder is insoluble, with the liquid preferably being water. This brings along the advantage that the molding compound particles formed by the spray process and thus also the binder are cooled and an improved mechanical stability is thereby obtained.

The present invention furthermore relates to a thermoplastic molding compound powder that is manufactured in accordance with one of the claims 1 to 15.

The binder used within the framework of the present invention preferably has a melt viscosity of 10⁰ Pa·s to 10⁶ Pa·s, in particular of 10⁰ Pa·s to 10⁵ Pa·s, and in particular of 10⁰ Pa·s to 10⁴ Pa·s at a temperature that is at least 10° C. above a temperature Tₛ, with the temperature Tₛ being a glass transition temperature or a crystallite melting temperature of the binder and with a speed drop in particular being selected from the group 1.00 s⁻¹, 2.50 s⁻¹, 5.00 s⁻¹, 10.0 s⁻¹, 25.0 s⁻¹, 50.0 s⁻¹ and 100 s⁻¹.

The determination of the melt viscosity preferably takes place in accordance with DIN EN ISO 3219 (Status: October 1994). The indicated values of the melt viscosity in particular apply to a speed drop of 1.00 s⁻¹. The temperature Tₛ is the glass transition temperature with an amorphous structure of the binder and is the crystallite melting temperature, in particular the maximum crystallite melting temperature, with a part-crystalline binder.

It is particularly advantageous if the molding compound particles of the molding compound powder have a size in the range of >0.05 mm, preferably <0.2 mm, preferably 0.05 mm to 0.15 mm, and particularly preferably 0.10 mm.

Provision is preferably made that the molding compound particles each have a maximum dimension Aₘₐₓ and 0.005 mm≤Aₘₐₓ≤0.3 mm, in particular 0.008 mm≤Aₘₐₓ≤0.2 mm, and in particular 0.01 mm≤Aₘₐₓ≤0.1 mm applies to at least 80% of the molding compound particles.

Provision can furthermore be made that the molding compound particles each have a minimum dimension Aₘᵢₙ and a maximum dimension Aₘₐₓ and 0.6≤Aₘᵢₙ/Aₘₐₓ≤1, in particular 0.7≤Aₘᵢₙ/Aₘₐₓ≤1, and in particular 0.8≤Aₘᵢₙ/Aₘₐₓ≤1 applies to at least 80% of the molding compound particles.

As already stated above, it is particularly advantageous if the molding compound particles of the molding compound powder are spherical.

The present invention furthermore relates to the use of a thermoplastic molding compound powder in accordance with the invention as a starting material for a powder-based, additive production process.

Further details and advantages of the invention will be explained in more detail with reference to an embodiment shown in the drawing.

There are shown:

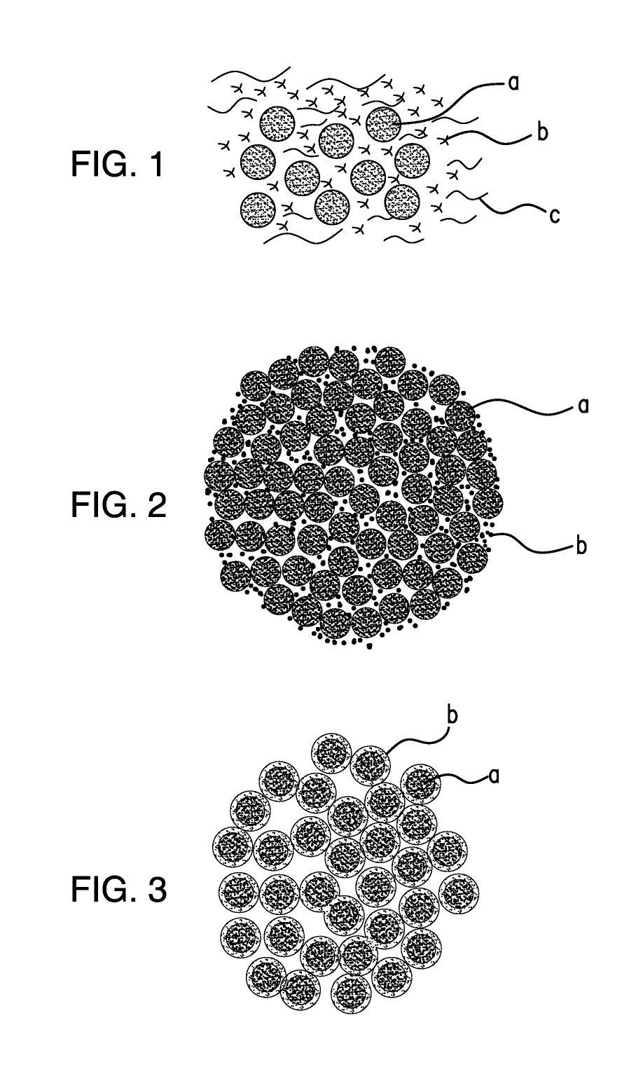

FIG. 1: a schematic representation of a suspension that is intended for supply into a spray dryer;

FIG. 2: a schematic representation of the spherical molding compound particles acquired by spray drying the suspension in accordance with FIG. 1; and

FIG. 3: a schematic representation of a molding compound particle obtained by spray drying an aqueous suspension.

FIG. 1 shows by reference symbol a metallic substrate particles, e.g. of stainless steel, titanium, etc. that are received in a liquid alcoholic suspension. The alcoholic medium is marked by the reference symbol c. The binder or binder components b is molecularly dissolved in this medium.

If the suspension shown in FIG. 1 is subjected to a spray drying in that the suspension is directly introduced into a spray dryer at elevated temperature, the alcohol evaporates so that the binder comprising the plasticizer and the metallic particles remain. The binder comprising the plasticizer acts as an adhesion agent between the individual metallic substrate particles and holds them together in a spherical structure that is shown in FIG. 2.

FIG. 2 thus shows a molding compound particle of which the feedstock compound, i.e. the thermoplastic molding compound powder, consists in accordance with the invention. As can be seen from FIG. 2, the molding compound particle is ball-shaped or substantially ball-shaped.

It has a diameter of <0.2 mm and can be brought into a melt, preferably into a low-viscosity melt, at a temperature of or from 150° C. without application of pressure, with the melt then being able to be processed into a molding in a 3D printing process.

The molding compound particles in accordance with FIG. 2 have a good flowability that is in particular significant for coating with a doctor blade as part of a 3D printing process. A further advantage of the molding compound particles in accordance with the invention comprises the fact that they bring about a correspondingly low operating temperature of the 3D printer due to their property of melting at comparatively low temperatures.

The use of the molding compound particles in accordance with the invention is particularly advantageous with a powder-based, additive production process such as in a 3D SLS method (SLS=selective laser sintering).

A molding compound particle can be seen from FIG. 3 that was not obtained through the method in accordance with the invention. This particle was obtained by the spray drying of an aqueous suspension that has substrate particles a that are coated by the binder b that was deposited by precipitation on the substrate particle.

While agglomerates in accordance with FIG. 3 and having a comparatively open porosity between the individual binder-coated substrate particles are obtained in the spray drying of the aqueous suspension, a denser structure of powder and binder results on a spray drying from an alcoholic solution in accordance with the invention, as can be seen from a comparison of FIGS. 2 and 3. This means that the base density of the feedstock particles obtained in accordance with the invention is higher than that of the feedstock particles acquired from the aqueous suspension.

Higher green densities or bulk densities are of substantial significance for the sintering density later present at the sintered molding on a laser sintering.

1. A method of manufacturing thermoplastic molding compound powder that consists of or comprises spherical or approximately spherical molding compound particles from a suspension of glass-like and/or ceramic and/or metallic substrate particles in a solvent in which a binder is dissolved that has a polymer soluble in the solvent, wherein the binder furthermore has one or more additives soluble in the solvent, with the method comprising the step of spray drying the suspension and with the spray drying being carried out such that the solvent partially or completely transitions into the gas phase.

2. A method in accordance with claim 1, characterized in that the additive or additives is/are molecularly dissolved in the suspension.

3. A method in accordance with claim 1, characterized in that the additive or additives is/are one or more of the substances: plasticizer, mold lubricant, additive that forms an at least binary system with the polymer.

4. A method in accordance with claim 1, characterized in that the polymer is thermoplastic; and/or in that the polymer is selected from one or more of the substances: Polycondensates; polymerizates; or polyadducts.

5. A method in accordance with claim 3, characterized in that the plasticizer is an ester of an aromatic hydroxybenzoic acid.

6. A method in accordance with claim 1, characterized in that the substrate particles each have a maximum dimension Bₘₐₓ and 1 μm≤Bₘₐₓ≤50 μm, that applies to at least 80% of the substrate particles.

7. A method in accordance with claim 1, characterized in that the molding compound particles each have a maximum dimension Aₘₐₓ and 0.005 mm≤Aₘₐₓ≤0.3 mm, that applies to at least 80% of the molding compound particles.

8. A method in accordance with claim 1, characterized in that the molding compound particles each have a minimum dimension Aₘᵢₙ and a maximum dimension Aₘₐₓ and 0.6≤Aₘᵢₙ/Aₘₐₓ≤1, that applies to at least 80% of the molding compound particles.

9. A method in accordance with claim 1, characterized in that the solvent is one or more alcohols or one or more alcoholic media.

10. A method in accordance with claim 1, characterized in that the substrate particles consist of one or more of the substances: precious metal, hard metal, glass, ceramics, non-ferrous metal, iron, titanium, their alloys and/or compounds, superalloys and steel or comprise one or more of these substances or metals, alloys or compounds.

11. A method in accordance with claim 1, characterized in that the ceramic and/or metallic and/or glass-like substrate particles are first introduced into the solvent comprising the binder and this suspension is then atomized in a spray system with a partial or complete evaporation of the solvent.

12. A method in accordance with claim 11, characterized in that the introduction of the ceramic and/or metallic and/or glass-like substrate particles takes place at elevated temperature.

13. A method in accordance with claim 1, characterized in that the spray process is carried out at a temperature that is 10° C.-30° C. below the crystallization temperature of the additive polymer.

14. A method in accordance with claim 1, characterized in that the method is carried out such that the suspension is sprayed into a liquid in which the binder is insoluble.

15. A method in accordance with claim 1, characterized in that the binder has a melt viscosity of 10⁰ Pa·s to 10⁶ Pa·s, at a temperature that is at least 10° C. above a temperature Tₛ, with the temperature Tₛ being a glass transition temperature or a crystallite melting temperature of the binder and with a speed drop in particular being selected from the group 1.00 s⁻¹, 2.50 s⁻¹, 5.00 s⁻¹, 10.0 s⁻¹, 25.0 s⁻¹, 50.0 s⁻¹ and 100 s⁻¹.

16. A thermoplastic molding compound powder, characterized in that the molding compound powder is manufactured in accordance with claim 1.

17. A thermoplastic molding compound powder in accordance with claim 16, characterized in that the binder has a melt viscosity of 10⁰ Pa·s to 10⁶ Pa·s, at a temperature that is at least 10° C. above a temperature Tₛ, with the temperature Tₛ being a glass transition temperature or a crystallite melting temperature of the binder and with a speed drop in particular being selected from the group 1.00 s⁻¹, 2.50 s⁻¹, 5.00 s⁻¹, 10.0 s¹, 25.0 s⁻¹, 50.0 s⁻¹ and 100 s⁻¹.

18. A thermoplastic molding compound powder in accordance with claim 16, characterized in that the molding compound particles of the molding compound powder each have a maximum dimension Aₘₐₓ and 0.005 mm≤Aₘₐₓ≤0.3 mm, that applies to at least 80% of the molding compound particles.

19. A thermoplastic molding compound powder in accordance with claim 16, characterized in that the molding compound particles each have a minimum dimension Aₘᵢₙ and a maximum dimension Aₘₐₓ and 0.6≤Aₘᵢₙ/Aₘₐₓ≤1, that applies to at least 80% of the molding compound particles.

20. A thermoplastic molding compound powder in accordance with claim 16, characterized in that the molding compound particles of the molding compound powder are spherical and have a plurality of ceramic and/or metallic and/or glass-like substrate particles.

21. A method for powder-based additive manufacturing comprising printing with a thermoplastic molding compound powder in accordance with claim 16.
